(19) United States
(12) Patent Application Publication
(10) Pub. No.: US 2023/0110234 A1
(43) Pub. Date: Apr. 13, 2023

(54) BOARD TO BOARD POSITIONING DEVICE

(71) Applicant: HANWIT PRECISION INDUSTRIES LTD., New Taipei (TW)

(72) Inventors: Ming-De WU, New Taipei (TW); Ching-Kai CHANG, New Taipei (TW); Ying-Chih TSENG, New Taipei (TW)

(21) Appl. No.: 17/713,429

(22) Filed: Apr. 5, 2022

Related U.S. Application Data
(63) Continuation-in-part of application No. 17/510,777, filed on Oct. 26, 2021.

(30) Foreign Application Priority Data
Oct. 8, 2021 (TW) 110137595

(51) Int. Cl. F16B 21/02; F16B 5/06

(52) U.S. Cl. CPC F16B 21/02; F16B 5/0621; F16B 2005/0671

(57) ABSTRACT

A board to board positioning device includes a base including a shaft hole inside, two through hole arranged at two opposite sides perpendicular to the shaft hole and respectively mounted with a limiting ball, a connecting portion and a limiting portion respectively provided at two sides and two limiting grooves for aligning with the two through holes, and an adjustment knob including an operation space for the base to pass through, a sliding wall surface positioned against the through holes, a driving portion positioned against the limiting portion and a marking portion provided on the outside. The sliding wall surface has a pressing side and a retreating side used to push the limiting balls into and out of the through holes. The driving portion is protruded with locking protrusions that are used to rotate and slide along the limiting portion to enter and exit the limiting grooves.

This application is a Continuation-In-Part of application Ser. No. 17/510,777, filed on Oct. 26, 2021, for which priority is claimed under 35 U.S.C. § 120, the entire contents of which are hereby incorporated by reference.

This application claims the priority benefit of Taiwan patent application number 110137595, filed on Oct. 8, 2021.

### BACKGROUND OF THE INVENTION

### 1. Field of the Invention

The present invention relates to fasteners more particularly, to a board to board positioning device, which facilitates identification of the locked or unlocked state. The board to board positioning device comprises a base, and an adjustment knob covering the base rotatable to move internal limiting balls of the base. Through the identification means set on the outer edge of the adjustment knob, it is convenient to operate the positioning device to lock or unlock.

### 2. Description of the Related Art

Generally, when assembling and joining common plates (board-to-board), they are usually locked with positioning screws with knobs, collars and screws. The assembly procedure is to fix the screws and collars on the outer plate member first, and turn the knobs to lock the screws into the inner plate member, and then use a hand tool to fasten tight the screws, so that the outer plate member and the inner plate member are locked together as a whole. This multi-layer plate member locking mode can be applied to the field of working mother machine or other board-to-board connection plates. However, these work machines need to use plates for locking, most of which are power devices or speed adjustment devices, etc. The various power devices and speed adjustment devices are located inside the space formed by the machine housing, which can be assembled, locked and disassembled by means of plate activity. When the power device crashes, fails, or is damaged, or when the speed adjustment device changes or adjusts the speed, remove the plate members for related maintenance and adjustment operations. The plate members are locked by a plurality of positioning screws, so it is easy to cause the positioning screws to fall off and lose during the disassembly process, and it is impossible to re-lock the plate members back to the original position, which will cause inconvenience and trouble in assembly and disassembly. In order to solve the shortcomings that the locking screws are easy to lose, some companies have developed a fixing device composed of a cap, a screw rod and a positioning block. First buckle the positioning block of the fixing device into the perforation of the plate member, and then use the screw rod to lock it to another plate member to form a fix. When the user disassembles the plate member, the fixing device can still be fixed in the perforation of the plate member through the positioning block, so that the fixing device will not fall off or lose. However, in the assembly process, the user must use force or hand tools (such as: screwdriver or wrench, etc.) to control the locking or disassembly of the fixing device. There are still many defects and problems in practical applications.

However, when applied to the combination of two opposing plates by locking and fixing, under the requirements of mass production and processing efficiency that pay attention to modularization, the tedious manual assembly process using screws will seriously affect the progress of the manufacturer's shipment, and the screws are easy to be lost in the process of locking the two plates due to their small size, and it will be difficult to assemble, align or lock due to the difference in the size of the screw holes at the screw locking position or the inconsistency of the number of screw holes and the pitch of the screw holes. Moreover, the space for operating the screws between the two opposing plates is quite narrow, that is, when the screws are assembled and disassembled, it is easy to be obstructed by surrounding objects, which is not only time-consuming and inconvenient, but also leads to an increase in the overall cost. This increases the burden on the industry.

Therefore, how to solve the problem and inconvenience that the fixing device used in the current plate locking is easy to be loosened and disengaged by wrong rotation, and the trouble and inconvenience of applying force or using hand tools when assembling the fixing device is the direction that the relevant manufacturers in this industry are eager to study and improve.

### SUMMARY OF THE INVENTION

The present invention has been accomplished under the circumstances in view. It is therefore a main object of the present invention to provide a board to board positioning device, which comprises a base and an adjustment knob. The base comprises a shaft hole inside, at least one through hole arranged on an inner wall surface of the shaft hole and penetrating toward the outside in the direction perpendicular to the shaft hole, a limiting ball respectively installed inside each through hole, a connecting portion and a limiting portion respectively provided on outer two sides of the base, and at least one limiting groove provided on the limiting portion for aligning with the at least one through hole. The adjustment knob comprises an operation space for the base to pass through to expose the connecting portion to the outside of the operation space, a sliding wall surface provided inside the operation space and positioned against the at least one through hole, a driving portion provided inside the operation space and positioned against the limiting portion, and a marking portion provided on the outside of the adjustment knob relative to the at least one locking protrusion. The sliding wall surface is provided with a pressing side and a retreating side. The pressing side and the retreating side are used to push the at least one limiting ball into and out of the at least one through hole. The driving portion is protruded with at least one locking protrusion. The at least one locking protrusion is used to rotate and slide along the limiting portion to enter and exit the at least one limiting groove. Through the marking portion set on the outer edge of the adjustment knob, it is convenient to operate the positioning device to lock or unlock.

It is another object of the present invention to provide a board to board positioning device, wherein the base comprises two through holes arranged on an inner wall surface of the shaft hole at two opposite sides and penetrating toward the outside in the direction perpendicular to the shaft hole, one limiting ball respectively installed inside each through hole, and two limiting grooves provided on the limiting portion for aligning with the two through holes respectively. The limiting portion on the outer side of the base is provided with two opposing limiting grooves corresponding to the two symmetrically arranged through holes, and two suspension grooves respectively spaced from the two opposing limiting grooves at a preset angle between 60°˜120°, and preferably 90°. Preferably, the connecting portion of the base comprises a ring groove mounted with a limit washer, and a mounting groove for the positioning of a first positioning hole of a preset first plate.

It is still another object of the present invention to provide a board to board positioning device, wherein the sliding wall surface and the driving portion of the adjustment knob are stacked up inside the operation space for the connecting portion of the base to pass through to let the adjustment knob expose to the outside. The pressing side of the sliding wall surface has a relatively smaller inner diameter and is located corresponding to the locking protrusion of the driving portion, the retreating side of the sliding wall surface has a relatively greater inner diameter, and the inner diameters of the pressing side and the retreating side are both smaller than the size of the operation space. Preferably, the marking portion of the adjustment knob is selectively in the shape of a convex rod, a cylinder or a plate.

It is still another object of the present invention to provide a board to board positioning device, which comprises a base, and adjustment knob, and an axle seat. The base comprises a shaft hole inside, at least one through hole arranged on an inner wall surface of the shaft hole and penetrating toward the outside in the direction perpendicular to the shaft hole, a limiting ball respectively installed inside each through hole, a connecting portion and a limiting portion respectively provided on outer two sides of the base, and at least one limiting groove provided on the limiting portion for aligning with the at least one through hole. The adjustment knob comprises an operation space for the base to pass through to expose the connecting portion to the outside of the operation space, a sliding wall surface provided inside the operation space and positioned against the at least one through hole, a driving portion provided inside the operation space and positioned against the limiting portion, and a marking portion provided on the outside of the adjustment knob relative to the at least one locking protrusion. The sliding wall surface is provided with a pressing side and a retreating side. The pressing side and the retreating side are used to push the at least one limiting ball into and out of the at least one through hole. The driving portion is protruded with at least one locking protrusion. The at least one locking protrusion is used to rotate and slide along the limiting portion to enter and exit the at least one limiting groove. The axle seat comprises a seat body located outside the base, a shaft rod extending outward from one side of the seat body and penetrating into the shaft hole of the base, a stop block provided on the suspended side of the shaft rod, and a concave ring groove provided at the shaft rod between the stop block and the seat body in alignment with the at least one through hole so that the limiting ball in each through hole can be locked or withdrawn from the concave ring groove, it is convenient to operate the positioning device to lock or unlock.

It is still another object of the present invention to provide a board to board positioning device, wherein the outer diameter of the seat body of the axle seat is larger than the outer diameter of the base and smaller than the outer diameter of the adjustment knob, and the outer diameter of the shaft rod is smaller than the diameter of the shaft hole. Preferably, the axle seat further comprises a connecting side provided on the other side of the seat body relative to the shaft rod for a second positioning hole of a preset second plate to be inserted and fixed. Preferably, the stop block of the axle seat comprises a first guide inclined surface that is tapered and inclined to extend to the concave ring groove, and a second guide inclined surface that is tapered and inclined to extend opposite to the first guide inclined surface.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a board to board positioning device in accordance with the present invention.

FIG. 2 is an exploded view of the board to board positioning device in accordance with the present invention.

FIG. 3 corresponds to FIG. 2 when viewed from another angle.

FIG. 4 is a sectional side view of the board to board positioning device in accordance with the present invention.

FIG. 5 is a top view of the present invention before the axle seat and adjustment knob are rotated.

FIG. 6 is a top view of the present invention after the axle seat and adjustment knob are rotated.

FIG. 7 is a side sectional view of the preferred embodiment of the present invention.

### DETAILED DESCRIPTION OF THE PREFERRED EMBODIMENT

In order to achieve the above objects and effect, the technical means used in the present invention and its structure, implementation method, etc., the preferred embodiment of the present invention is hereby described in detail and its features and functions are as follows, so as to be fully understood.

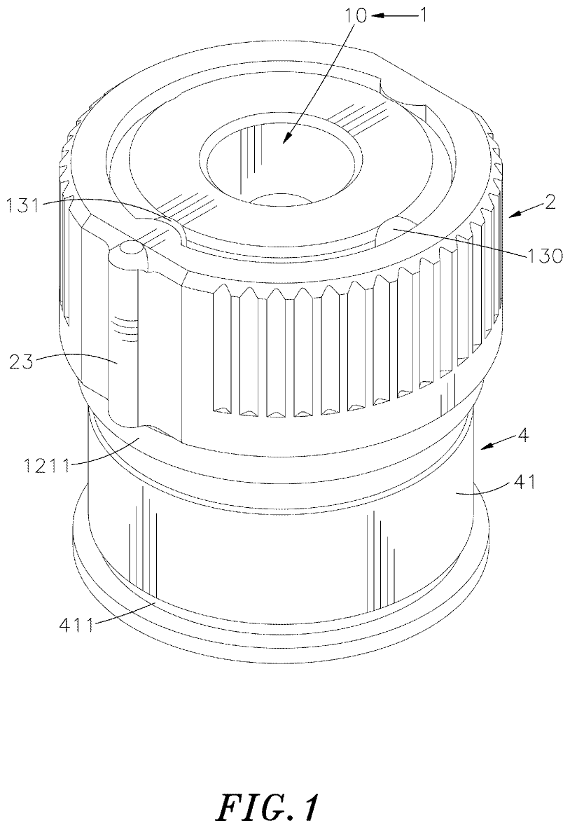

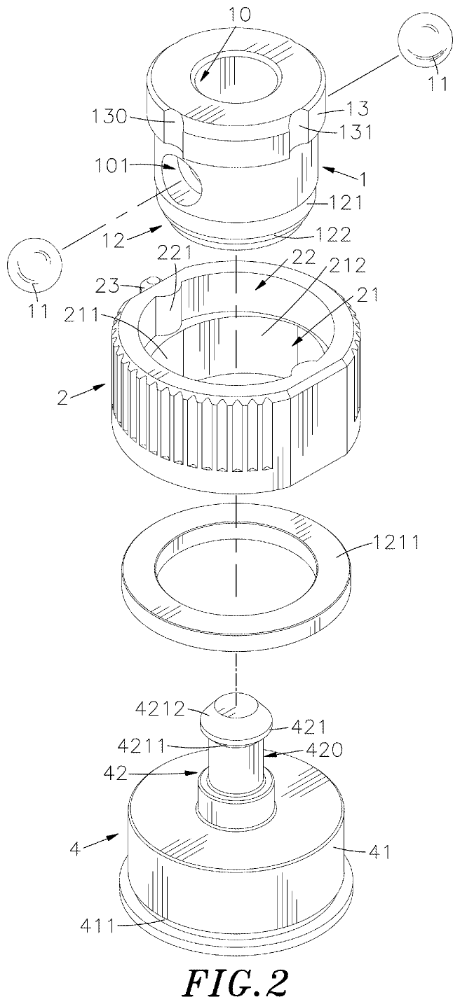

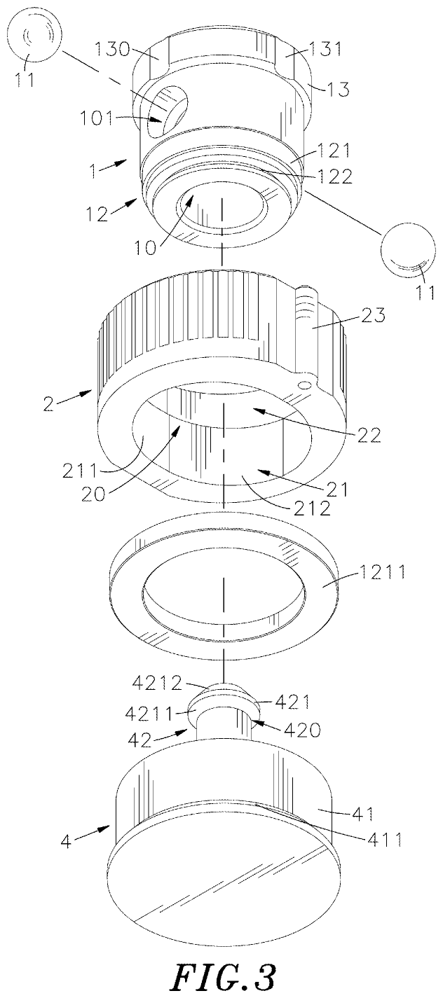

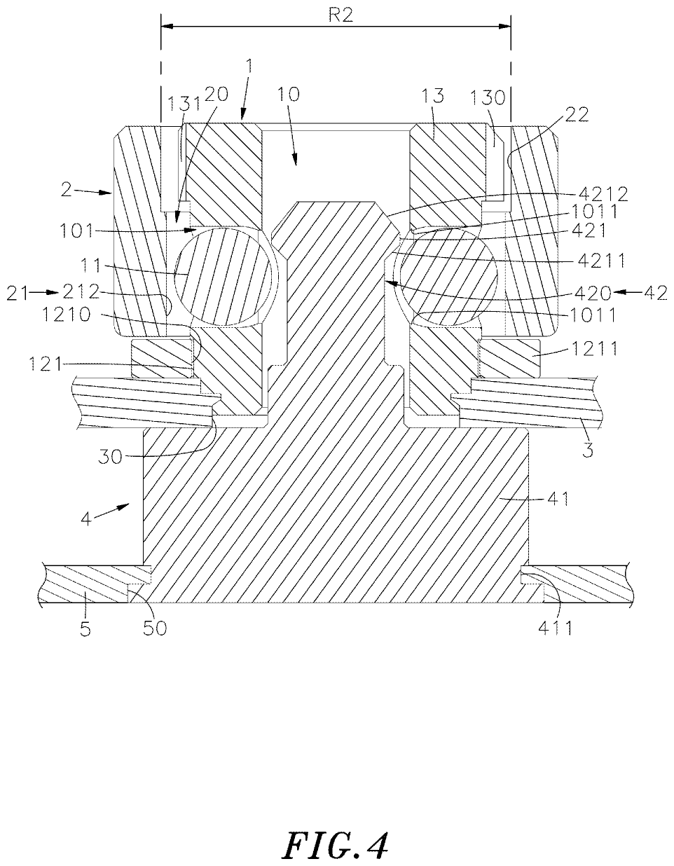

Please refer to FIGS. 1-4, where FIG. 1 is an oblique top elevational view of a board to board positioning device in accordance with the present invention, FIG. 2 is an exploded view of the board to board positioning device in accordance with the present invention, FIG. 3 corresponds to FIG. 2 when viewed from another angle, and FIG. 4 is a sectional side view of the board to board positioning device in accordance with the present invention. It can be clearly seen from the drawings that the board to board positioning device of the present invention comprises a base 1 and an adjustment knob 2.

The base 1 has a through shaft hole 10 inside, and at least one through hole 101 is arranged on the inner wall surface of the shaft hole 10 and penetrates toward the outside in the direction perpendicular to the shaft hole 10. The periphery of the hole edge of each through hole 101 adjacent to the shaft hole 10 is provided with a blocking ring edge 1011 with an inwardly reduced hole diameter. A limiting ball 11 is respectively installed inside each through hole 101, and the limiting ball 11 is stopped by the blocking ring edge 1011 located at the periphery of the inner hole edge of the associating through hole 101, which can effectively prevent the limiting ball 11 from falling into the shaft hole 10. A connecting portion 12 and a limiting portion 13 are respectively provided on the outer two sides of the base 1, and at least one limiting groove 130 is provided on the limiting portion 13 for aligning with the at least one through hole 101.

The adjustment knob 2 is covered on the outside of the base 1, and is provided with an operation space 20 for the base 1 to pass through, and the connecting portion 12 on one side of the base 1 exposes the outside of the operation space 20. Inside the operation space 20 are respectively provided with adjacently stacked sliding wall surface 21 and driving portion 22, and the sliding wall surface 21 is positioned against the at least one through hole 101 and the driving portion 22 is positioned against the limiting portion 13. The sliding wall surface 21 is provided with a pressing side 211 and a retreating side 212 with different inner diameters that are side by side, so as to use the pressing side 211 and the retreating side 212 to push the at least one limiting ball 11 into and out of the at least one through hole 101. The driving portion 22 is protruded with at least one locking protrusion 221, which can be used to rotate and slide along the limiting portion 13 to enter and exit the at least one limiting groove 130. A marking portion 23 is provided with the outside of the adjustment knob 2 relative to the at least one locking protrusion 221.

The above-mentioned base 1 can be provided with at least two through holes 101 symmetrically arranged on at least two opposite wall surfaces of the inner shaft hole 10 in direction perpendicular to the vertical shaft hole 10. In each through hole 101, a limiting ball 11 is movably installed, respectively. The limiting portion 13 on the outer side of the base 1 is provided with two opposing limiting grooves 130 corresponding to the two symmetrically arranged through holes 101. Suspension grooves 134 are respectively provided on the other two opposite sides at a preset angle relative to the opposing limiting grooves 130, and the preset angle can be between 60°˜120°, and a better preset angle can be 90°. The connecting portion 12 on one side of the base 1 comprises a ring groove 121 for the mounting of a limit washer 1211, and a mounting groove 122 for the positioning of a first positioning hole 30 of a preset first plate 3.

The above-mentioned operation space 20 of the adjustment knob 2 comprises the adjacently stacked sliding wall surface 21 and driving portion 22, so that the connecting portion 12 on one side of the base 1 penetrates through the sliding wall surface 21 and the driving portion 22 to expose to the outside of the adjustment knob 2. The pressing side 211 of the sliding wall surface 21 has a relatively smaller inner diameter (R1) and is located corresponding to the locking protrusion 221 of the driving portion 22. The retreating side 212 adjacent to the pressing side 211 has a relatively larger inner diameter (R2). The marking portion 23 provided on the outside of the adjustment knob 2 is in the shape of a convex rod, a cylinder or a plate. The inner diameters of the pressing side 211 and the retreating side 212 are both smaller than the size of the operation space 20.

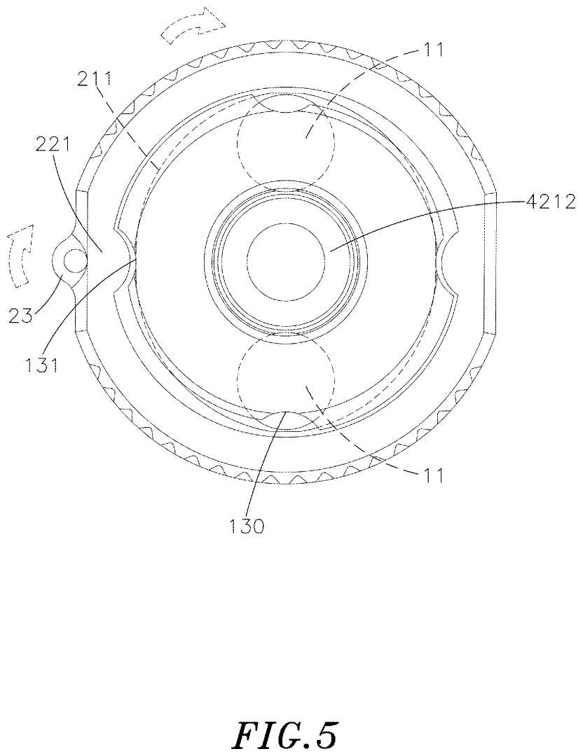

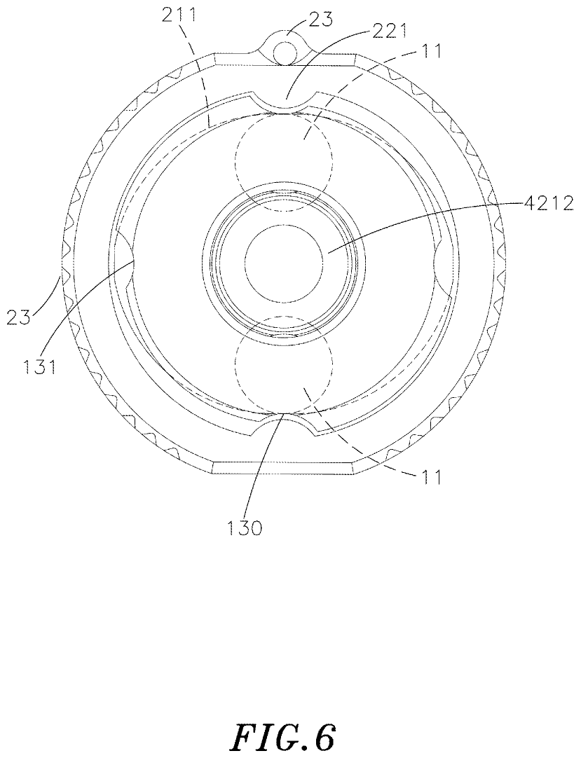

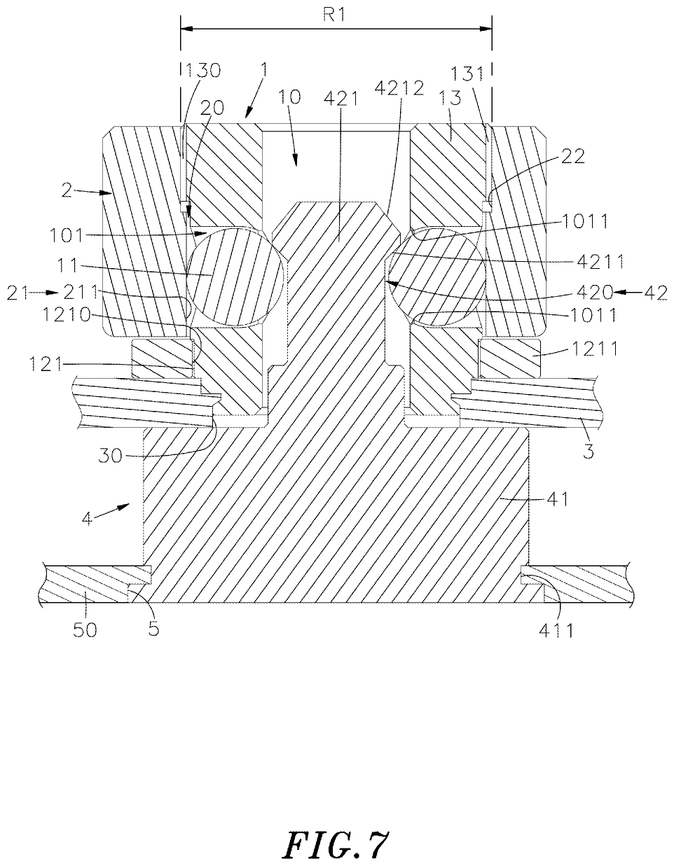

Please refer to FIGS. 2-7, where FIG. 2 is an exploded view of the board to board positioning device in accordance with the present invention, FIG. 3 corresponds to FIG. 2 when viewed from another angle, FIG. 4 is a sectional side view of the board to board positioning device in accordance with the present invention, FIG. 5 is a top view of the present invention before the axle seat and adjustment knob are rotated, FIG. 6 is a top view of the present invention after the axle seat and adjustment knob are rotated, and FIG. 7 is a side sectional view of the preferred embodiment of the present invention. The board to board positioning device of the present invention further comprises a base 1, an adjustment knob 2, and an axle seat 4.

The base 1 comprises a through shaft hole 10 inside, two through holes 101 arranged on the inner wall surface of the shaft hole 10 and penetrated toward the outside in the direction perpendicular to the shaft hole 10, a limiting ball 11 respectively installed inside each through hole 101, and a connecting portion 12 and a limiting portion 13 respectively provided on the outer two sides of the base 1, and two limiting grooves 130 provided on the limiting portion 13 for aligning with the two through holes 101 outside.

The adjustment knob 2 is covered on the outside of the base 1, and is provided with an operation space 20 for the base 1 to pass through, and the connecting portion 12 on one side of the base 1 exposes the outside of the operation space 20. The connecting portion 12 on one side of the base 1 comprises a ring groove 121 for a ring hole 1210 of a limit washer 1211 to be sleeved and fixed at the ring groove 121 of the connecting portion 12, and a mounting groove 122 for the positioning of a first positioning hole 30 of a preset first plate 3. Use the limit washer 1211 to stop at the bottom of the adjustment knob 2 to prevent the adjustment knob 2 from leaving the base 1, so that base 1 can be set within the operation space 20 of the adjustment knob 2. Inside the operation space 20 are respectively provided with adjacently stacked sliding wall surface 21 and driving portion 22, and the sliding wall surface 21 is positioned against the through holes 101 and the driving portion 22 is positioned against the limiting portion 13. The sliding wall surface 21 is provided with a pressing side 211 and a retreating side 212 with different inner diameters that are side by side, so as to use the pressing side 211 and the retreating side 212 to push the two limiting balls 11 into and out of the respective through holes 101, so that part of the volume of the two limiting balls 11 enters the shaft hole 10 respectively, and is stopped by a blocking ring edge 1011 around the inner hole edge of each through hole 101, which can prevent the limiting ball 11 from falling into the shaft hole 10. The driving portion 22 is protruded with at least one locking protrusion 221, which can be used to rotate and slide along the limiting portion 13 to enter and exit the at least one limiting groove 130. A marking portion 23 is provided with the outside of the adjustment knob 2 relative to the at least one locking protrusion 221.

The axle seat 4 comprises a seat body 41 located outside the base 1, a shaft rod 42 extending outward from one side of the seat body 41 and penetrating into the shaft hole 10 of the base 1, a stop block 421 provided on the suspended side of the shaft rod 42 can pass through the through holes 101, and a concave ring groove 420 provided at the shaft rod 42 between the stop block 421 and the seat body 41. The through holes 101 are aligned through the concave ring groove 420, and the limiting balls 11 located in the through holes 101 can be locked or withdrawn from the concave ring groove 420.

The outer diameter of the seat body 41 of the above-mentioned axle seat 4 is larger than the outer diameter of the base 1 and smaller than the outer diameter of the adjustment knob 2. The outer diameter of the shaft rod 42 extending from the seat body 41 is smaller than the shaft hole 10. A connecting side 411 is provided on the other side of the seat body 41 relative to the shaft rod 42, which is for a second positioning hole 50 of a preset second plate 5 to be inserted and fixed. The stop block 421 of the shaft rod 42 is provided with a first guide inclined surface 4211 that is tapered and inclined to extend to the concave ring groove 420, and a second guide inclined surface 4212 is provided on the other side of the stop block 421 and tapered and inclined to extend opposite to the first guide inclined surface 4211.

The above-mentioned axle seat 4 can use the shaft rod 42 on one side of the seat body 41 to pass through the operation space 20 of the adjustment knob 2, and then pass into the shaft hole 10 of the base 1. When the stop block 421 on one side of the shaft rod 42 enters the shaft hole 10, the second guide inclined surface 4212 on one side of the stop block 421 can push the limiting balls 11 into the through holes 101 respectively for the shaft rod 42 and the stop block 421 penetrates into the shaft hole 10 smoothly.

The above-mentioned board to board positioning device of the present invention can rotate the adjustment knob 2 during practical application and implementation. The outer marking portion 23 of the adjustment knob 2 is opposite to at least one locking protrusion 221 of the inner driving portion 22, so that the at least one locking protrusion 221 can be rotated to the limiting groove 130 of the limiting portion 13 located at the base 1. At the same time, the at least one locking protrusion 221 is stacked on the pressing side 211 of the adjacent sliding wall surface 21, that is, it is rotated to the at least one through hole 101 located at the base 1, and the pressing side 211 with the smaller inner diameter pushes the limiting ball 11 in each through hole 101 to enter the shaft hole 10. Then the limiting ball 11 is stopped by the blocking ring edge 1011 around the inner hole edge of the associating through hole 101, so that each limiting ball 11 can be prevented from falling into the shaft hole 10. By setting the shaft hole 10 of the base 1 and passing through the shaft rod 42 of the axle seat 4, the limiting balls 11 in the through holes 101 on the two sides of the shaft hole 10 of the base 1 are displaced along the second guide inclined surface 4212 over the stop block 421 to enter the first guide inclined surface 4211 and engaged in the concave ring groove 420 of the shaft rod 42. Thus, the preset first plate 3 positioned on the outside of the adjustment knob 2 is positioned on the seat body 41 of the axle seat 4 and is fixed on the connecting side 411 at the side of the preset second plate 5.

If you want to take out and separate the preset second plate 5 from the preset first plate 3, you can turn the adjustment knob 2 again. The outer marking portion 23 of the adjustment knob 2 is rotated relative to at least one locking protrusion 221 of the inner driving portion 22, and is rotated from the limiting groove 130 of the limiting portion 13 to the position opposite to the suspension groove 131 located on the other side of the limiting portion 13. At the same time, the pressing side 211 of the adjacent sliding wall surface 21 is rotated away from the two opposite through holes 101 of the base 1, and the adjacent retreating side 212 is displaced to the through holes 101. The limiting ball 11 is then slid into the through hole 101 along the first guide inclined surface 4211 from the concave ring groove 420 by the retreating side 212 of the larger inner diameter, and the limiting balls 11 on the two sides are displaced from the shaft hole 10 into the retreating side 212 of the adjustment knob 2. The shaft rod 42 of the axle seat 4 can then be taken out from the shaft hole 10 of the base 1, and then the preset second plate 5 embedded at the connecting side 411 of the seat body 41 of the axle seat 4 is separated from the preset first plate 3 side.

The above description is only a preferred embodiment of the present invention, and it does not limit the scope of the patent of the present invention. Therefore, any simple modifications and equivalent structural changes made by using the contents of the description and drawings of the present invention should be similarly included in the scope of the patent of the present invention.

To sum up, the above-mentioned board to board positioning device of the present invention can indeed achieve its effect and purpose when it is used, so the present invention is a creation with excellent practicability. In order to meet the application requirements for an invention patent, an application should be filed in accordance with the law. It is hoped that the review committee will approve the case as soon as possible to protect the hard work of the inventor. If the review committee has any doubts, please do not hesitate to send a letter for instructions, the inventor will do his best to cooperate

What the invention claimed is:

1. A board to board positioning device, comprising:
a base, said base comprising a shaft hole inside, at least one through hole arranged on an inner wall surface of said shaft hole and penetrating toward the outside in the direction perpendicular to said shaft hole, a limiting ball respectively installed inside each said through hole, a connecting portion and a limiting portion respectively provided on outer two sides of said base, and at least one limiting groove provided on said limiting portion for aligning with said at least one through hole; and
an adjustment knob covered on said base, said adjustment knob comprising an operation space for said base to pass through to expose said connecting portion to the outside of said operation space, a sliding wall surface provided inside said operation space and positioned against said at least one through hole, a driving portion provided inside said operation space and positioned against said limiting portion and a marking portion provided on the outside of said adjustment knob relative to at least one locking protrusion, said sliding wall surface being provided with a pressing side and a retreating side, said pressing side and said retreating side being used to push said at least one limiting ball into and out of said at least one through hole, said driving portion being protruded with said at least one locking protrusion, said at least one locking protrusion being used to rotate and slide along said limiting portion to enter and exit said at least one limiting groove.

2. The board to board positioning device as claimed in claim 1, wherein said base comprises two said through holes arranged on an inner wall surface of said shaft hole at two opposite sides and penetrating toward the outside in the direction perpendicular to said shaft hole, one said limiting ball respectively installed inside each said through hole, and two said limiting grooves provided on said limiting portion for aligning with said two through holes respectively; said limiting portion on the outer side of said base is provided with two opposing said limiting grooves corresponding to the two symmetrically arranged said through holes and two suspension grooves respectively spaced from two opposing said limiting grooves at a preset angle.

3. The board to board positioning device as claimed in claim 2, wherein said preset angle is between 60°˜120°, and preferably 90°.

4. The board to board positioning device as claimed in claim 1, wherein said connecting portion of said base comprises a ring groove mounted with a limit washer, and a mounting groove for the positioning of a first positioning hole of a preset first plate.

5. The board to board positioning device as claimed in claim 1, wherein said sliding wall surface and said driving portion of said adjustment knob are stacked up inside said operation space for said connecting portion of said base to pass through to let said adjustment knob expose to the outside; said pressing side of said sliding wall surface has a relatively smaller inner diameter and is located corresponding to said locking protrusion of said driving portion, said retreating side of said sliding wall surface has a relatively greater inner diameter, and the inner diameters of said pressing side and said retreating side are both smaller than the size of said operation space.

6. The board to board positioning device as claimed in claim 1, wherein said marking portion of said adjustment knob is selectively in the shape of a convex rod, a cylinder or a plate.

7. A board to board positioning device, comprising:
a base, said base comprising a shaft hole inside, and at least one through hole arranged on an inner wall surface of said shaft hole and penetrating toward the outside in the direction perpendicular to said shaft hole, a limiting ball respectively installed inside each said through hole, a connecting portion and a limiting portion respectively provided on outer two sides of said base, and at least one limiting groove provided on said limiting portion for aligning with said at least one through hole;
an adjustment knob covered on said base, said adjustment knob comprising an operation space for said base to pass through to expose said connecting portion to the outside of said operation space, a sliding wall surface provided inside said operation space and positioned against said at least one through hole, a driving portion provided inside said operation space and positioned against said limiting portion and a marking portion provided on the outside of said adjustment knob relative to at least one locking protrusion, said sliding wall surface being provided with a pressing side and a retreating side, said pressing side and said retreating side being used to push said at least one limiting ball into and out of said at least one through hole, said driving portion being protruded with said at least one locking protrusion, said at least one locking protrusion being used to rotate and slide along said limiting portion to enter and exit said at least one limiting groove; and
an axle seat comprising a seat body located outside of said base, a shaft rod extending outward from one side of said seat body and penetrating into said shaft hole of said base, a stop block provided on the suspended side of said shaft rod can pass through said at least one through hole, and a concave ring groove provided at said shaft rod between said stop block and said seat body in alignment with said at least one through hole so that said limiting ball in each said through hole is able to be locked or withdrawn from said concave ring groove.

8. The board to board positioning device as claimed in claim 7, wherein the outer diameter of said seat body of said axle seat is larger than the outer diameter of said base and smaller than the outer diameter of said adjustment knob; the outer diameter of said shaft rod is smaller than the diameter of said shaft hole; said axle seat further comprises a connecting side provided on the other side of said seat body relative to said shaft rod for a second positioning hole of a preset second plate to be inserted and fixed.

9. The board to board positioning device as claimed in claim 7, wherein said stop block of said axle seat comprises a first guide inclined surface that is tapered and inclined to extend to said concave ring groove, and a second guide inclined surface that is tapered and inclined to extend opposite to said first guide inclined surface.
